(19) United States
(12) Patent Application Publication
(10) Pub. No.: US 2016/0204508 A1
(43) Pub. Date: Jul. 14, 2016

(54) SYSTEMS AND METHODS FOR CONTROLLING THE TRANSMISSION AND RECEPTION OF INFORMATION SIGNALS AT INTENDED DIRECTIONS THROUGH AN ANTENNA ARRAY

(71) Applicant: ALTAMIRA TECHNOLOGIES CORPORATION, McLean, VA (US)

(72) Inventor: Ryan CHRISTOPHER, Las Cruces, NM (US)

(21) Appl. No.: 14/594,718

(22) Filed: Jan. 12, 2015

(51) Int. Cl. H01Q 3/26

(52) U.S. Cl. CPC H01Q 3/2605

(57) ABSTRACT

Systems and methods are disclosed herein for controlling communication of information signals at an intended direction that involves (i) obtaining a set of changing weighting solutions for an antenna array having two or more antenna array elements, each of the weighting solutions defining a set of array weights that generates an imposed error as a function of direction in one or more of amplitude, phase, frequency and polarization of an information signal transmitted or received by the antenna array, wherein the imposed error for all of the changing weighting solutions is substantially the same at an intended direction and varies at unintended directions; (ii) selecting one of the changing weighting solutions; (iii) applying the set of array weights of the selected changing weighting solution to a set of antenna signals corresponding to the information signal transmitted or received through the antenna array elements; and (iv) selecting and applying each of the changing weighting solutions to the set of antenna signals according to a selection change rate, so that the information signal is recoverable at the intended direction and unrecoverable at all unintended directions.

### GOVERNMENT SUPPORT

The invention was supported, in whole or in part, by a contract W911QX-14-C-008 from United States Army Research Laboratory. The Government has certain rights in the invention.

### FIELD

The present application relates to systems and methods for controlling the transmission and reception of information signals through an antenna array. More particularly, the present application relates to systems and methods for controlling the transmission and reception of information signals through an antenna array such that they are recoverable at intended direction(s) and not recoverable at other unintended directions.

### BACKGROUND

Traditional antennas are designed to focus where transmit power is sent and from where receive power is received. An antenna gain pattern may be used to represent the profile of transmit and/or receive power of an antenna as a function of direction (e.g., azimuth angle). For example, traditional omnidirectional antennas are designed to provide a gain pattern in which power is focused evenly in all directions. Traditional directional antennas are designed to focus the majority of power in one or more specific directions. Traditional electronically steerable arrays are designed to focus power in a range of directions that is dynamically configurable without physically moving the array.

In order to successfully receive and operate on a Radio Frequency (RF) transmission, sufficient power must be received and the transmitted information must be present and uncorrupted within required signal quality limits. In traditional antenna and antenna array implementations, the requirement for sufficient power received to overcome RF noise and noise inherent to the receiver system is the limiting case. The information is encoded as a combination of amplitude, frequency, phase, and polarization changes applied to the transmitted signal. If there is sufficient power available to resolve the signal from the noise, the information is present to be acted upon. In traditional antenna and antenna array designs, it is assumed that the information is present when sufficient power is present.

A RF signal transmitted by a transmitter and received by a receiver is comprised of a transmitted signal generated and encoded by the transmitter, focused by the transmit antenna or antenna array pattern, modified by the electromagnetic path between the transmitter and the receiver, and finally weighted by the preferential reception versus angle (e.g., Azimuth, Elevation) of the receiver antenna or antenna array. The center frequency, modulation, protocol, data encoded and other transmitted signal characteristics are determined by the transmitter. The transmit antenna or antenna array is then used to preferentially send power in certain directions and reduce power sent in other directions. Similarly, the receiver antenna or antenna array is used to preferentially receive power from certain directions and reduce power received from other directions.

The electromagnetic path between transmitter and receiver varies depending on the environment and geometry of the transmitter and receiver and is practically unknowable for real world situations. The unknown electromagnetic path causes changes in the amplitude, phase, polarization and frequency content of the transmitted signal. However, these path induced changes (or path errors) occur slowly compared to the data signal encoded in the transmitted signal frequency phase, amplitude, and polarization. Since the path errors are slow and continuous in nature, traditional receivers make use of an equalizer that is able to track out and compensate for these errors in the received signal. As a result, a demodulator may ignore these path errors and act upon the relative amplitude, phase, frequency, or polarization that corresponds to the data encoded by the transmitter. Since path error is unknown and handled by the equalizer in traditional receivers, it is traditionally omitted during antenna array design.

Although all traditional antennas may focus power in specific directions, power is transmitted and received in all directions (albeit at lower power levels in some directions). Therefore, the information contained within the signals transmitted or received by a traditional antenna also exist in all directions. The gain pattern for a traditional antenna may impose a signal-to-noise ratio (SNR) penalty at unintended directions where signal power levels are reduced. However, this penalty may be overcome by using a receiver having more gain, greater sensitivity, or at a location closer in proximity to the antenna. When this penalty is overcome, the contained information is fully accessible and may be intercepted, jammed, spoofed or used to form unintended communications links by third parties located at an unintended direction.

### SUMMARY

Embodiments of the invention are disclosed herein for controlling the transmission and/or reception of radio frequency (RF) information signals through an antenna array in intended direction(s), such that the information is recoverable from information signals received at intended direction(s). Conversely, the information is corrupted and not recoverable from information signals received at all other unintended directions despite sufficient power being present. This effect is referred to herein as Advanced Spatial Information Control (“the ASIC effect”), which is substantially different from traditional antenna array which are only used to preferentially direct power.

Such embodiments may involve selecting and applying a changing set of different array weighting solutions on the information signals transmitted or received through the antenna array. Each of the different array weighting solutions define a unique set of array weights that imposes error in one or more of amplitude, phase, frequency and polarization of the information signal according to the direction of the transmission or reception (“ASIC error(s)”). The imposed ASIC error due to each of the array weighting solutions is substantially the same at the intended direction(s) and varies at unintended directions. Because the imposed ASIC error on the information signal is substantially the same at the intended direction regardless of weighting solution, the information signal can be recovered through known traditional receiver functionality. Conversely, because the imposed ASIC error on the information signals varies in a fashion similar to the encoded data at each unintended direction when applying a changing set of different weighting solutions to the transmitted signal, the receiver interprets the imposed ASIC error as intended information, thereby unrecoverably destroying the encoded data sent by the transmitter at each desired unintended direction.

Various embodiments provide methods, devices, systems, and non-transitory processor-readable storage media for a computing device to control communication of information signals at an intended direction through an antenna array. An embodiment method may include obtaining a set of changing weighting solutions for an antenna array having two or more antenna array elements, each of the weighting solutions defining a set of array weights that generates an imposed error as a function of direction in one or more of amplitude, phase, frequency and polarization of an information signal transmitted or received by the antenna array, wherein the imposed error for all of the weighting solutions is substantially the same at an intended direction and varies at unintended directions; selecting one of the changing weighting solutions; applying the set of array weights of the selected weighting solution to a set of antenna signals corresponding to the information signal being transmitted or received through the antenna array elements; and selecting and applying each of the weighting solutions to the set of antenna signals according to a selection change rate, so that the information signal is recoverable at the intended direction and unrecoverable at all unintended directions.

In some embodiments where the information signal is transmitted by the antenna array, the method may comprise accessing the set of changing weighting solutions for the antenna array; selecting one of the changing weighting solutions; applying the set of array weights of the selected weighting solution to a set of antenna feed signals representing the information signal being transmitted through the antenna array elements; and selecting and applying each of the weighting solutions to the set of antenna feed signals according to a selection change rate, so that the information signal is recoverable at the intended direction and unrecoverable at all unintended directions.

In some embodiments where the information signal is received by the antenna array, the method may comprise accessing the set of changing weighting solutions for the antenna array; selecting one of the changing weighting solutions; applying the set of array weights of the selected weighting solution to a set of antenna receive signals corresponding to an information signal being received through the antenna array elements; processing the set of antenna receive signals to produce a composite receive signal; and selecting and applying each of the weighting solutions to the set of antenna signals according to a selection change rate; wherein the information signal is recoverable from the composite receive signal when the set of antenna receive signals is received from the antenna array at the intended direction and wherein the information signal is not recoverable when the set of antenna receive signals is received from the antenna array at any of the unintended directions.

Further embodiments may include a computing device for controlling communication of information signals at an intended direction that comprises a processor configured with processor-executable instructions for performing operations of the methods described above. Further embodiments may include a computing device for controlling communication of information signals at an intended direction that comprises means for performing the operations of the methods described above. Further embodiments may include a non-transitory processor-readable storage medium on which is stored processor-executable instructions configured to cause a processor to perform operations of the methods described above.

In any of the foregoing embodiments, the intended direction may comprise a range of intended directions. The sequence for selecting and applying each of the weighting solutions may be a predetermined or random sequence. The selection change rate may be equal to, lower than or higher than a symbol rate of the information signal. The set of array weights may comprise one or more of amplitude and a phase corresponding to each antenna array element.

### BRIEF DESCRIPTION OF THE DRAWINGS

The accompanying drawings, which are incorporated herein and constitute part of this specification, illustrate exemplary embodiments of the invention, and together with the general description given above, and the detailed description given below, serve to explain the features of the invention.

FIG. 1 is a conceptual diagram for illustrating the ASIC effect using an antenna array.

FIGS. 2A through 2D illustrate exemplary amplitude and phase errors in information symbols due to the ASIC effect.

FIG. 3 is a diagram illustrating an analog transmitter system that implements the ASIC effect according to one embodiment.

FIG. 4 is a flow diagram illustrating a method of implementing the ASIC effect in transmit mode according to one embodiment.

FIGS. 5A, 5B and 5C are exemplary diagrams illustrating dynamic measured gain patterns of an antenna array according to the ASIC effect of different weighting solution sets.

FIG. 6 is a diagram illustrating an analog receiver system that implements the ASIC effect according to one embodiment.

FIG. 7 is a flow diagram illustrating a method of implementing the ASIC effect in receive mode according to one embodiment.

FIGS. 8A, 8B and 8C are exemplary diagrams comparing error imposed on an information signal as a function of direction for different types of data modulation and weighting solution sets.

FIG. 9 is a diagram illustrating a direct digital synthesis (DDS) transmitter system that implements the ASIC effect according to one embodiment.

FIG. 10 is a diagram illustrating a direct receiver system that implements the ASIC effect using a digital array post processing technique according to one embodiment.

### DETAILED DESCRIPTION

Various embodiments are described in detail herein with reference to the accompanying drawings. Wherever possible, the same reference numbers are used throughout the drawings to refer to the same or like parts. References made to particular examples and implementations are for illustrative purposes, and are not intended to limit the scope of the invention or the claims. Alternate embodiments may be devised without departing from the scope of the disclosure. Additionally, well-known elements of the disclosure may not be described in detail or may be omitted so as not to obscure the relevant details of the disclosure.

The word “exemplary” is used herein to mean “serving as an example, instance, or illustration.” Any implementation described herein as “exemplary” is not necessarily to be construed as preferred or advantageous over other implementations.

The term “substantially the same” is used herein to mean identical or similar to the extent that the differences are not significant.

As disclosed herein, a time varying and controllable error may be added to signals transmitted or received by an antenna array by switching between predetermined solution weights. The encoded data transmitted by the transmitter may be modified by the Advanced Spatial Information Control (“ASIC”) effect which is a function of angle (e.g., azimuth, elevation) and time. When the received signal in an unintended direction reaches the receiver device, the imposed ASIC errors may not be removable by the equalizer as the errors are non-continuous due to the instantaneous switching between selected weighting solutions. Such errors may occur below, at or above the data rate of the information signal. Equalizers may be intentionally designed to operate much below the data rate time scales to ensure that encoded data is not removed. As a result, the demodulator at a receiver, may receive a signal that includes both the encoded data and the imposed ASIC error. This may occur independent of whether the ASIC effect is applied to an antenna array operating at the transmit or receive side of an RF link. In particular, the demodulator interprets the ASIC errors in phase, amplitude, frequency, and polarization in the same manner as the encoded data. Therefore, the demodulator may incorrectly resolve bit errors, thereby causing unrecoverable destruction of the information that was originally encoded. This error may not be recoverable with additional antenna gain, transmit power, receiver sensitivity, or proximity as such enhancements all serve to increase the received power in order to improve the received signal to noise ratio (SNR). In contrast, the ASIC errors may be inseparable from the encoded data and correspondingly increase in power and continue to impose unrecoverable bit errors no matter how much power is received.

Embodiments of the invention are disclosed herein for controlling the transmission and/or reception of radio frequency (RF) information signals through an antenna array in intended direction(s), such that the information may be recoverable from information signals received at intended direction(s). Conversely, the information may be corrupted and not recoverable from information signals received at all other unintended directions despite sufficient power being present. Such embodiments may involve selecting and applying a changing set of different alternative array weighting solutions on the information signals transmitted or received through the antenna array. Each of the different weighting solutions may define a unique set of array weights that imposes error in one or more of amplitude, phase, frequency, and polarization of the information signal according to the direction of the transmission or reception. The imposed error due to each of the weighting solutions may be substantially the same at the intended direction(s) and varies at unintended directions. Because the imposed error on the information signal may be substantially the same at the intended direction regardless of weighting solution, the information may be recovered from the information signals received through traditional receiver functionality. Conversely, because the imposed error on the information signals may vary in a fashion similar to the encoded data at each unintended direction when applying a changing set of different weighting solutions to the transmitted signal, the receiver may interpret the imposed ASIC error(s) as intended information, thereby unrecoverably destroying the encoded data sent by the transmitter.

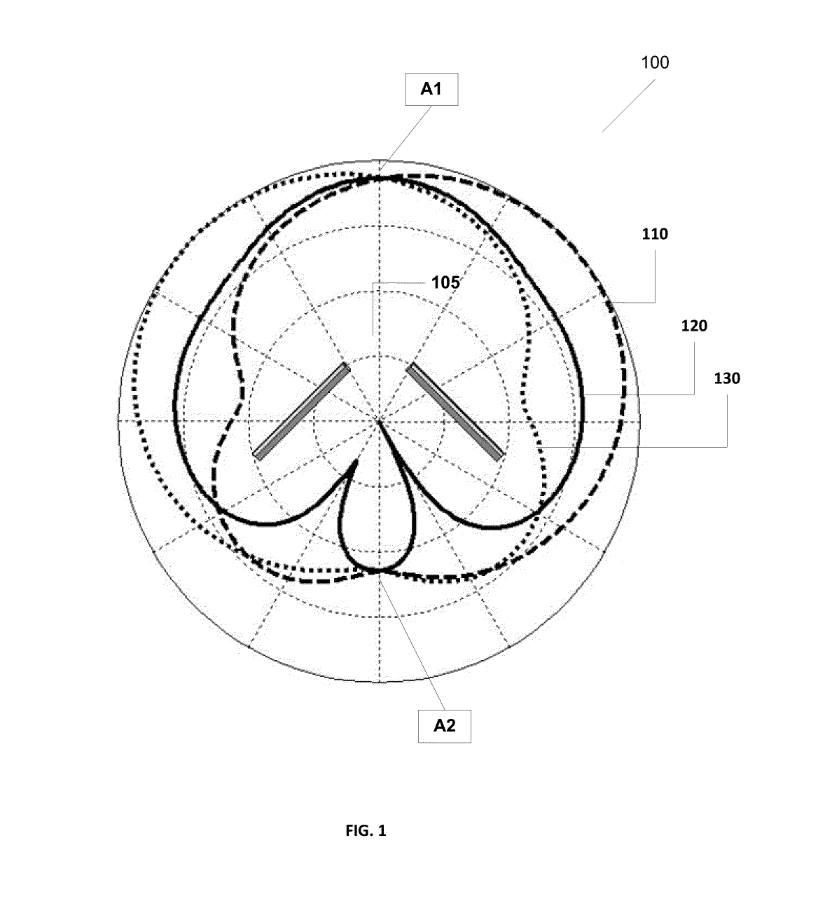

FIG. 1 is a conceptual diagram for illustrating the ASIC effect using an antenna array. In this example, the antenna array may be a two element array composed of patch antennas canted from each other at 90 degrees in order to more clearly show the ASIC effect by increasing the angular differences in the antenna patterns. Other antenna array configurations may be implemented. For example, one such antenna array configuration is a Direct Spatial Antenna Modulation (“DSAM”) antenna array. Embodiments of a DSAM antenna array are described in U.S. Pat. Nos. 8,391,376; 8,411,794; 8,457,251; and 8,340,197, the entire contents of which are incorporated herein by reference.

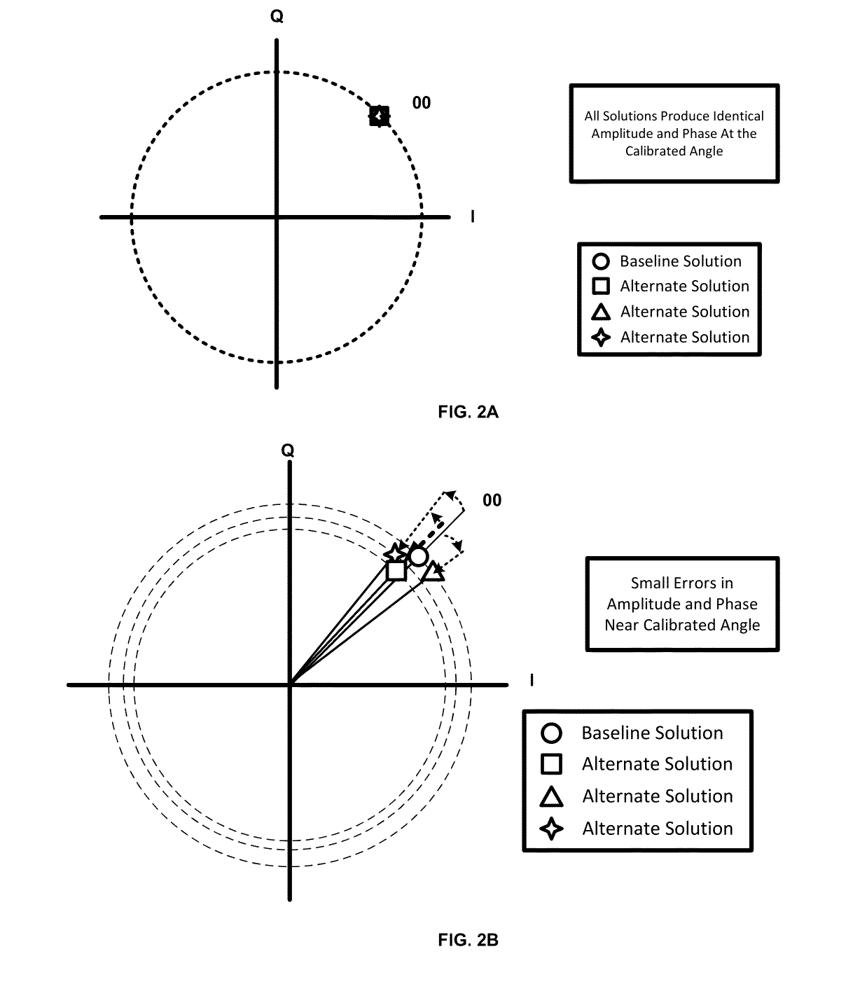

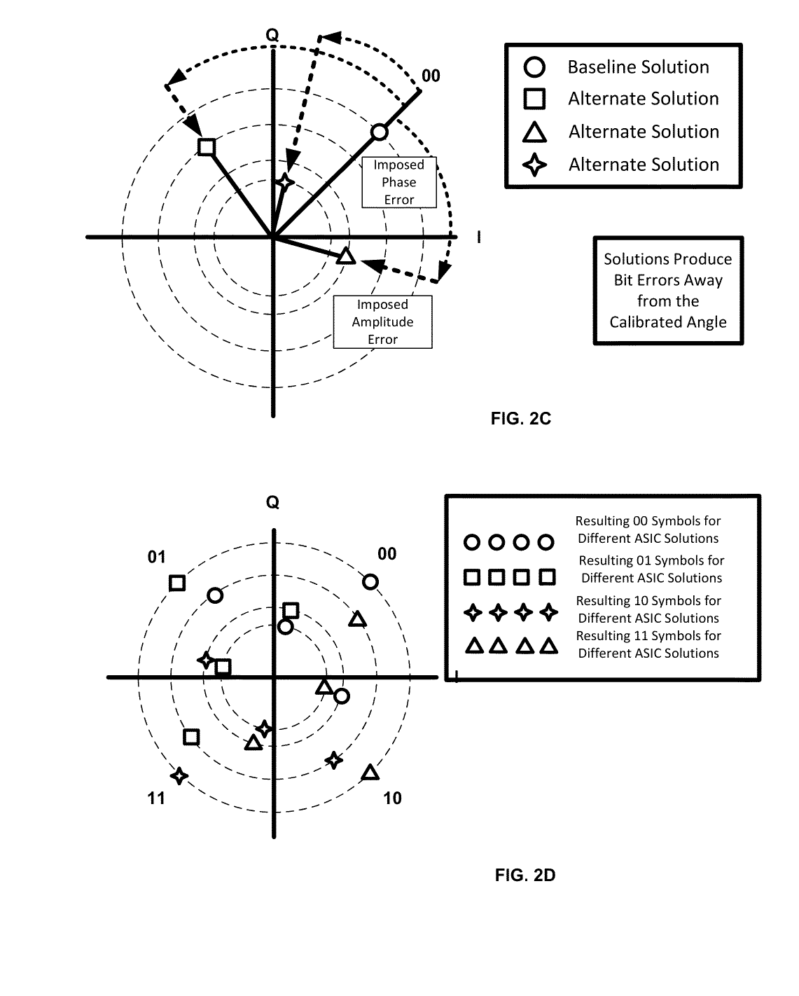

The antenna array 105, consisting of two antenna elements, may be operated using different weighting solutions to produce different antenna gain patterns 110, 120, 130. As shown, each of the gain patterns has substantially the same, if not identical, gain levels (solid and dotted lines) and phase responses (not shown) at intended angular directions (e.g., A1, A2). Conversely, the gain levels and phase responses in each of the gain patterns differ at other unintended directions. Thus, by applying the different weighting solutions to the antenna array according to a selection change rate, the antenna array may produce a dynamic gain pattern that is constant at the intended direction(s) and varies in time at other directions. As a result, significant amplitude, phase, polarization and frequency errors may be imposed on an information signal received at all directions except for the intended directions. The ASIC errors are deemed significant to the extent that they may affect the ability of a receiver to accurately recover the transmitted information signal (e.g., an encoded symbol). Although FIG. 1 relates to amplitude errors, the ASIC effect may also impose errors in phase, polarization, and frequency. For example, FIGS. 2A through 2D illustrate exemplary amplitude and phase errors in information symbols due to the ASIC effect.

FIG. 2A is an exemplary constellation map for a QPSK-encoded symbol (00) received at an intended direction. In this example, it may be assumed that all of the changing weighting solutions (◯, □, Δ, [symbol] ) may produce substantially the same gain level and phase response at the intended direction. As a result, substantially the same errors may be imposed on the amplitude, frequency, polarization and phase of the transmitted information symbol (e.g., symbol 00) when received at this intended direction regardless of the solution. Put other way, all of the weighting solutions may produce substantially the same amplitude and phase for this QPSK-encoded symbol (00) when received at this intended direction. Therefore, there may be a high likelihood that the transmitted symbol (00) may be accurately recovered at this direction.

FIG. 2B is an exemplary constellation diagram for the QPSK-encoded symbol (00) in which small errors in amplitude and phase are imposed when received at an angle near the intended direction. In this example, it may be assumed that each of the applied weighting solutions (◯, □, Δ, [symbol] ) may produce slight differences in the amplitude, frequency, polarization and phase response at this angle. As a result, small errors may be imposed on the amplitude and phase on the transmitted information symbol (00) when received at this angle due to the changing of the weighting solutions. Therefore, there may be a reduced likelihood that the transmitted symbol may be accurately recovered at this direction.

FIG. 2C is an exemplary constellation diagram for the QPSK-encoded symbol (00) in which significant errors may be imposed when received at an angle away from the intended direction. In this example, it may be assumed that each of the weighting solutions (◯, □, Δ, [symbol] ) produces significant differences in amplitude, frequency, polarization, and phase response at this angle. These differences may be deemed significant in that there is high likelihood that a transmitted information symbol may be incorrectly recovered by a receiver due to such amplitude, frequency, polarization and phase errors. For example, as shown in FIG. 2C, the amplitude and phase for the same information symbol (00) may fall into the wrong quadrant for a particular weighting solution (e.g., □, Δ). As a result, a receiver at this unintended direction may generate bit errors by inaccurately mapping a transmitted symbol to the wrong symbol in the constellation. The likelihood of such bit errors in a constellation for all 2-bit symbols (00, 01, 10, 11) is shown in more detail in FIG. 2D.

FIG. 2D is an exemplary constellation diagram that illustrates how amplitude, frequency, polarization and phase errors due to the ASIC effect at an unintended direction may increase the likelihood of bit errors during recovery of a set of QPSK-encoded symbols. In this example, the amplitude and phase errors due to different weighting solutions (◯,◯,◯,◯) for symbol 00 may be the same as the amplitude and phase errors shown in FIG. 2C. FIG. 2D further shows amplitude and phase errors due to different weighting solutions for symbols 01, 11, and 10. As shown, where the amplitude and phase errors imposed on symbol 00 cause the recovered amplitude and phase to fall within the second quadrant, there may be a high likelihood that the receiver may inaccurately map the received information signal to symbol 01. Likewise, where the amplitude and phase errors imposed on symbol 00 may cause the recovered amplitude and phase to fall within the fourth quadrant, there may be a high likelihood that the receiver may inaccurately map the received information signal to symbol 10. Therefore, as shown in FIGS. 2A through 2D, transmission and reception of recoverable information may be directed at an intended direction by proper selection and application of a changing set of different weighting solutions applied to information signals.

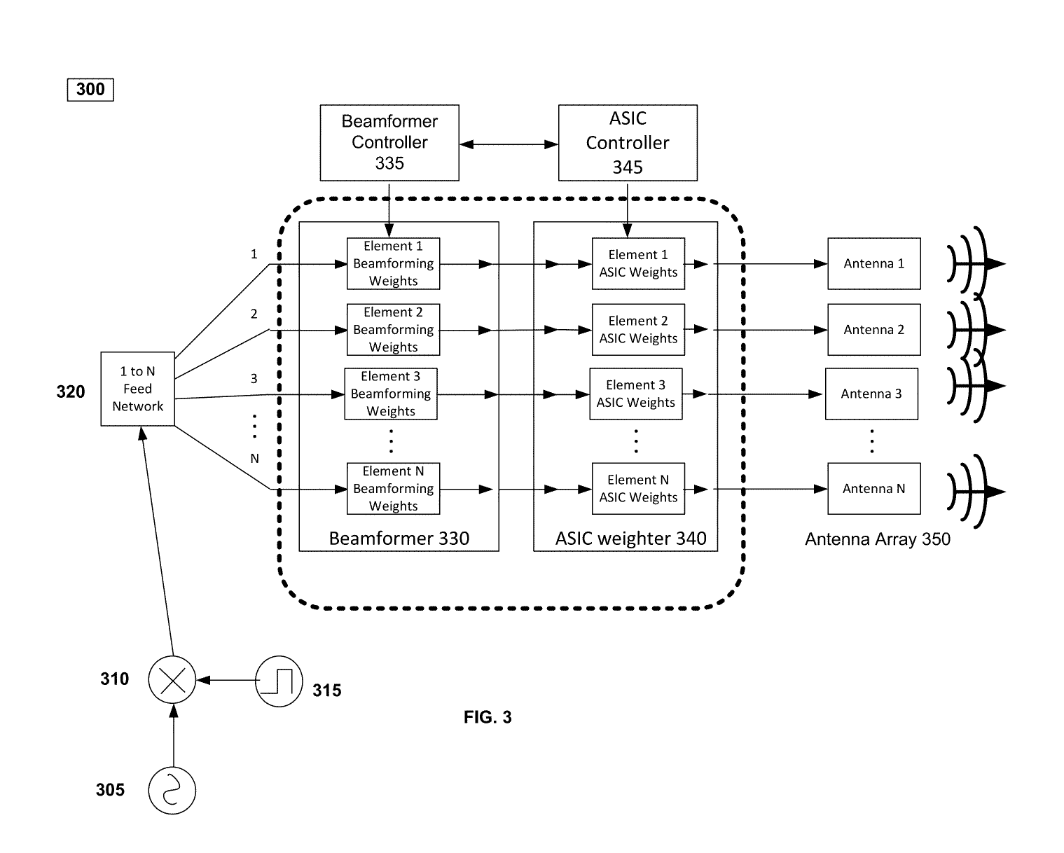

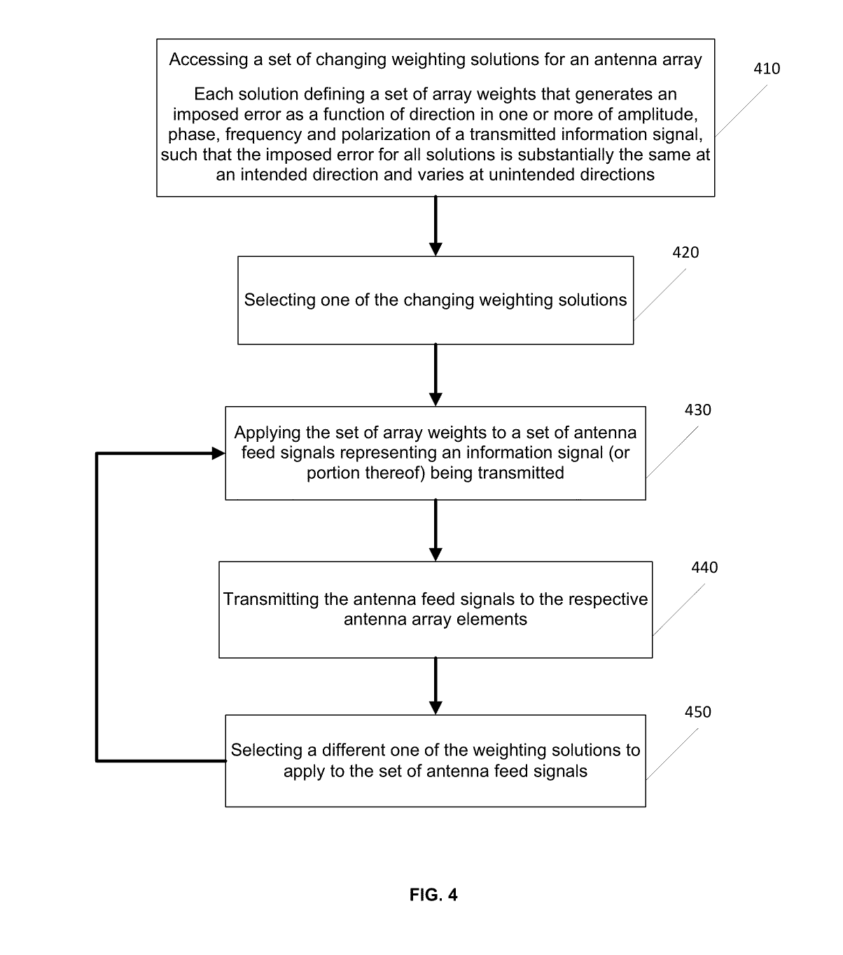

FIG. 3 is a diagram illustrating an analog transmitter system that implements the ASIC effect according to one embodiment. The transmitter system 300 may comprises a carrier wave source 305, a mixer 310, a digital data source 315, a 1 to N feed network 320, a beamformer 330, a beamform controller 335, a ASIC weighter 340, a ASIC controller 345, and an antenna array 350 comprising N antenna elements (where N≧2). Analog information signals, such as a data modulated carrier signal, may be generated by the mixer 310 processing a carrier signal from the carrier wave source 305 with digital data from a digital data source 315. The information signal may be compatible with any data rate, transmission frequency, modulation type, and protocol. The mixer 310 may send the information signal to the 1 to N feed network 320 to generate a set of N antenna feed signals (where N≧2). In one embodiment, the N antenna feed signals may be weighted in dual stages performed by the beamformer 330 and ASIC weighter 340, respectively. In another embodiment, the antenna feed signals may be weighted in a single stage by the beamformer 330 under the control of the beamformer controller 335 and/or the ASIC controller 345. Whether single stage or dual stage weighting is performed, the N weighted antenna feed signals may be transmitted to the antenna array 350, causing transmission of information signals according to the ASIC effect, and power to be sent according to the independent and potentially related beamforming directions.

FIG. 4 is a flow diagram illustrating a method of implementing the ASIC effect in transmit mode according to one embodiment. At 410, a set of changing weighting solutions exhibiting the ASIC effect (“ASIC solutions”) may be obtained for the antenna array. Each solution may define a set of array weights that generates an imposed error as a function of direction in one or more of amplitude, phase, frequency and polarization of a transmitted information signal. The imposed error may be substantially the same at intended direction(s) for all ASIC solutions and varies at all other unintended directions. The set of ASIC solutions may be obtained by retrieving a preconfigured set of ASIC solutions stored in a database or by dynamically calculating the set of ASIC solutions. A different set of ASIC solutions may be obtained at any time an indication of a change to the intended direction is received.

In a dual stage weighting embodiment, the ASIC controller 345 may obtain the set of ASIC solutions after a set of beamforming weights are applied to the antenna feed signals by the beamformer 330. The obtained set may be based on the applied set of beamforming weights that correspond to an intended direction and a desired far field state for that direction. For example, the set of ASIC solutions may define array weights that produce the desired ASIC effect in that direction when applied to the weighted antenna feed signals from the beamformer 330 in a rotating manner, for example.

In a single stage weighting embodiment, the ASIC controller 345 may obtain the set of ASIC solutions prior to weighting by the beamformer 330. The obtained set may be based on a request from the beamformer controller 335 indicating an intended direction and optionally a desired far field state in that direction. For example, the obtained set of ASIC solutions may define array weights that produce the desired ASIC effect in the intended direction when applied to the antenna feed signals from feed network 320 in a rotating manner, for example. The ASIC controller 345 may be separate from, or incorporated into, the beamformer controller 345.

At 420, one of the changing weighting solutions may be selected by the ASIC controller 345.

At 430, the set of array weights defined by the selected weighting solution may be applied to a set of antenna feed signals representing an information signal (or portion thereof) being transmitted. In the dual stage weighting embodiment, the ASIC weighter 340, under the control of the ASIC controller 345, may apply the ASIC array weights to the antenna feed signals from the beamformer 330. In the single stage weighting embodiment, the beamformer 330 may, under the control of the ASIC controller 345 (or under the combined control of the ASIC controller 345 and the beamformer controller 335), apply the ASIC array weights to the antenna feed signals from the feed network 320.

At 440, the weighted antenna feed signals may be relayed to the respective antenna array elements.

At 450, a different one of the weighting solutions may be selected to apply to the set of antenna feed signals back at 430. For example, the next weighting solution to apply may be selected according a predetermined or random sequence. The rate at which the different weighting solutions are selected and applied (“selection change rate”) may relate to the symbol rate of the information signal. For example, the selection change rate may be equal to the symbol rate of the information signal. As a result, errors that vary in amplitude, phase, polarization or frequency may be imposed in every transmitted information symbol at unintended directions. The selection change rate may also be lower than the symbol rate of the information. Put another way, the ASIC effect may be periodically turned off reverting operation of the antenna array to its traditional performance and functionality. As a result, errors may be periodically imposed in the information signal at unintended directions, such that data packets may be corrupted without altering the format of the transmitted signal due to the ASIC effect. The selection change rate may also be defined to be higher than a symbol rate of the information signal. Higher selection rates may produce a spread spectrum effect controllable as a function of direction, thereby altering the signal characteristics and bandwidth to a receiver located in an unintended direction.

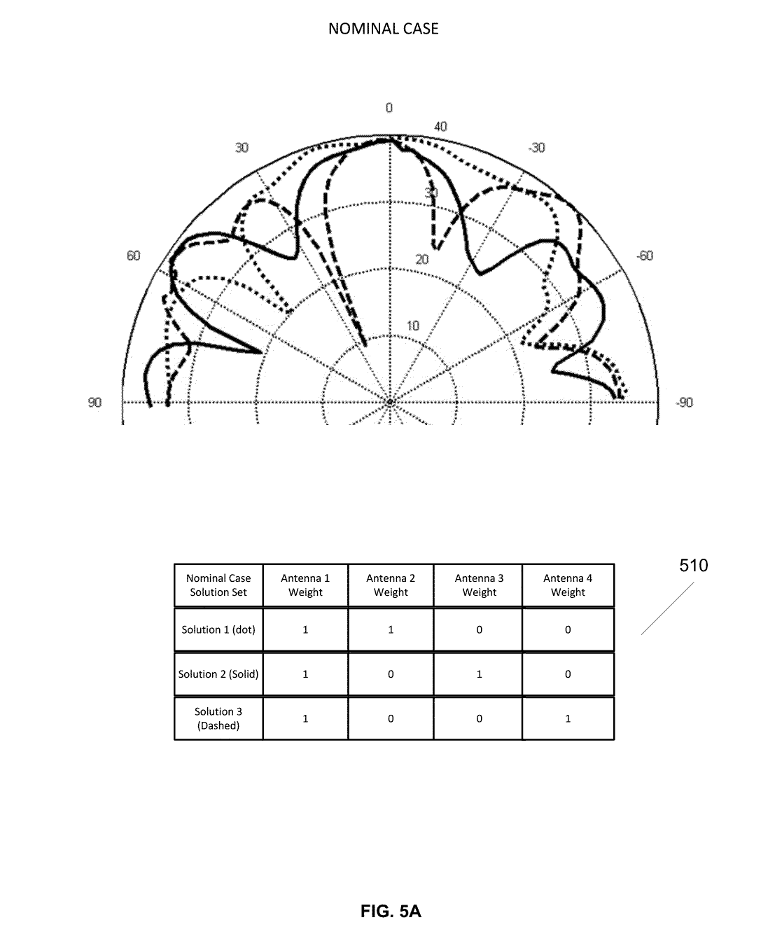

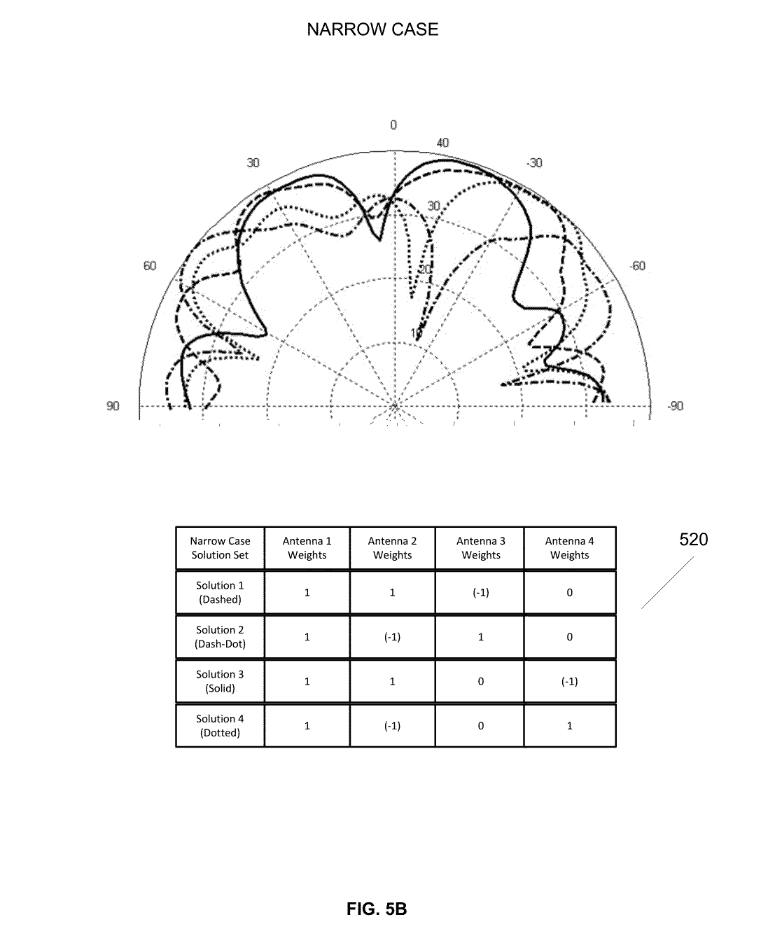

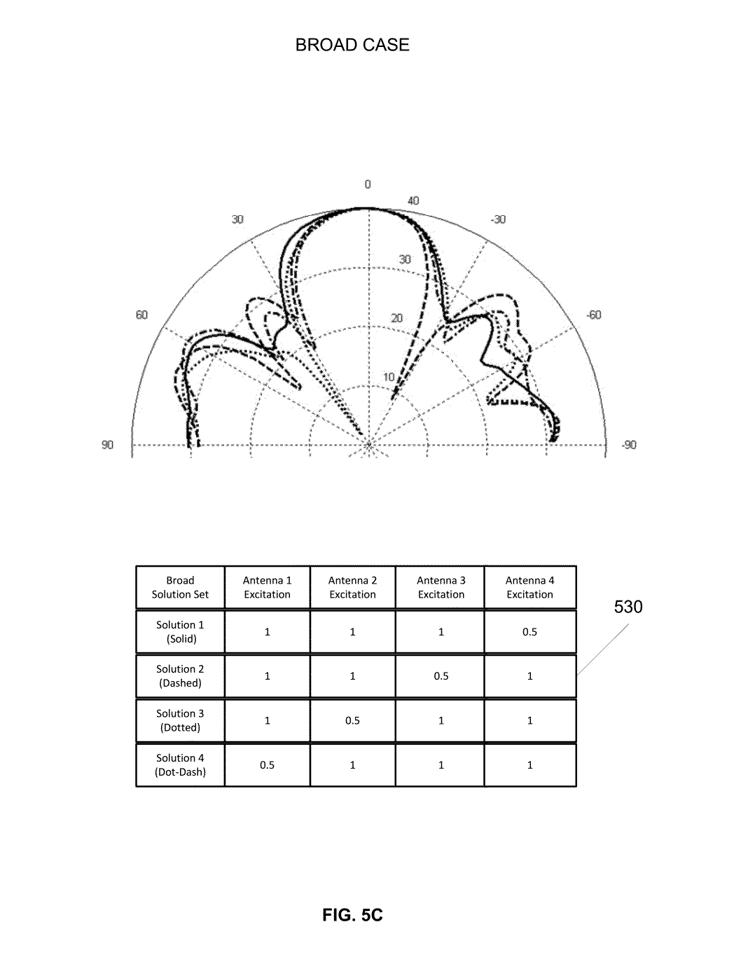

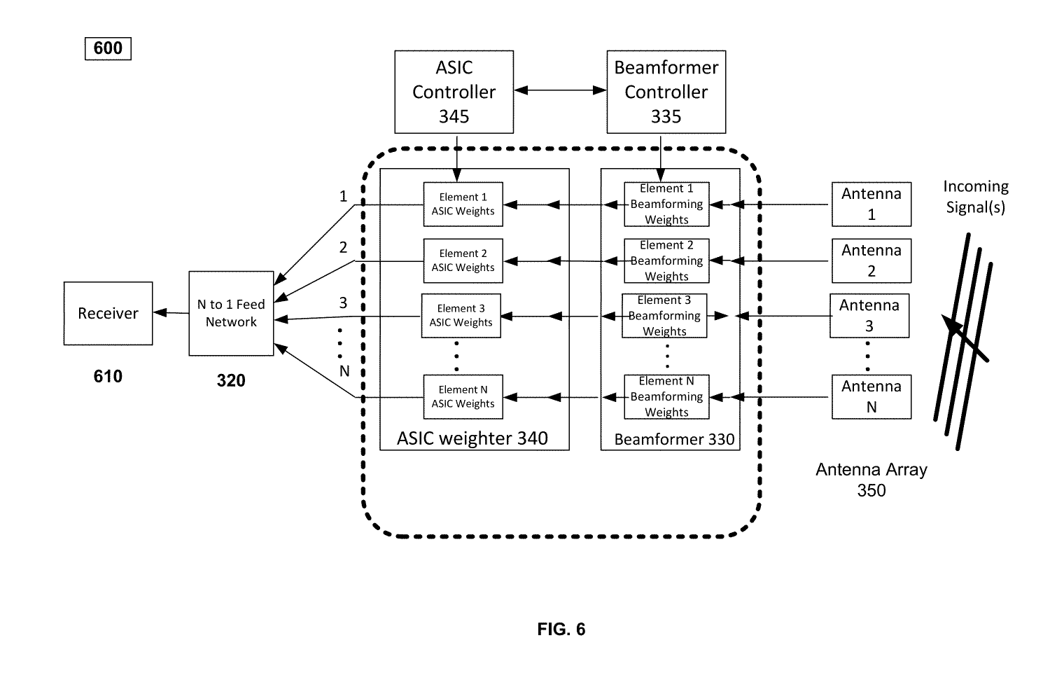

FIGS. 5A, 5B and 5C are exemplary diagrams illustrating dynamic gain patterns of an antenna array according to the ASIC effect of different weighting solution sets. For example, FIG. 5A illustrates the gain patterns corresponding to three different weighting solutions for an antenna array having four antenna elements. In this nominal case, the gain pattern corresponding to a first weighting solution, Solution 1, may be represented as a dotted line; the gain pattern corresponding to a second weighting solution, Solution 2, may be represented as a solid line; and the gain pattern corresponding to a third weighting solution, Solution 3, may be represented as a dashed line. Table 510 identifies a unique set of amplitude weights for each solution to apply to the antenna feed signals corresponding to the respective antenna elements. As shown, the gain patterns may be substantially the same at an intended angular direction within a nominal range between 0 and 10 degrees. As the angular direction deviates from this intended direction, the gain levels at each of the other unintended directions differ amongst the weighting solutions. For example, at an angular direction between 15 and 30 degrees, the gain levels amongst the different solutions vary significantly between 10 decibels (dB) to 40 dB. Thus, by changing the applied weighting solutions applied to the feed signals to the respective antenna elements, a receiver at an intended direction (e.g., 0 to 10 degrees) may experience substantially no difference in gain levels during recovery of the transmitted information signal. However, a receiver at an unintended direction may experience significant differences in gain levels during recovery of the transmitted information signal. As a result, there is a greater likelihood of bit errors at unintended directions due to the varying gain levels.

FIGS. 5B and 5C illustrates alternative sets of weighting solutions for a four-element antenna array that adjust the angular extents of the intended direction. For example, in FIG. 5B, Table 520 identifies a unique set of amplitude weights for each of four different solutions in which the intended direction at which the gain levels may be substantially the same is limited to a narrow range about zero (0) degrees. Conversely, in FIG. 5C, Table 530 identifies a unique set of amplitude weights for each of four different solutions in which the intended direction at which the gain levels may be substantially the same corresponds to a broader angular range approximately between 10 to (−10) degrees. Although FIGS. 5A, 5B and 5C illustrate weighting solutions having only amplitude weights, other embodiments may employ weighting solutions having weights that represent amplitude phase, polarization and frequency shifts.

In receive mode, ASIC weighting may also impose a set of fully controlled amplitude, phase and polarization errors that may vary as a function of angle to all received information signals. Such errors may be controlled so that they may collapse to zero in the direction(s) of an intended transmitter, and may be maximized in unintended directions. An antenna array in receive mode with ASIC weighting may only recover valid information signals from intended directions, with the information signals received from all other directions corrupted by the imposed errors. Therefore, embodiments of a ASIC receiver may reject information signals received from unintended directions. Thus, a ASIC receiver may prevent spoofing, coherently jamming, or injection of information signals by a transmitter sending information signals from an unintended direction even if the precise direction is unknown. Embodiments of the ASIC receiver may also spread power out of a channel that is received from unintended directions in a controllable manner, effectively reducing co-channel interference through spatially selective Direct Sequence Spread Spectrum (DSSS) enabled by ASIC.

FIG. 6 is a diagram illustrating an analog receiver system that implements the ASIC effect according to one embodiment. The receiver system 600 may comprise an antenna array 350 comprising N antenna elements (where N≧2), a beamformer 330, a beamform controller 335, a ASIC weighter 340, a ASIC controller 345, an N to 1 feed network 320, and a receiver 610. N antenna receive signals are received by N antenna elements of the antenna array 350. In one embodiment, the N antenna receive signals may be weighted in dual stages performed by the beamformer 330 and ASIC weighter 340, respectively, to produce the ASIC effect in receive mode. In another embodiment, the antenna receive signals may be weighted in a single stage by the beamformer 330 under the control of the beamformer controller 335 and/or the ASIC controller 345 to produce the effect. Whether single stage or dual stage weighting is performed, the N weighted antenna receive signals may then be transmitted to the N to 1 feed network 320. The feed network 320, in turn, may process the set of weighted antenna receive signals to produce a composite receive signal.

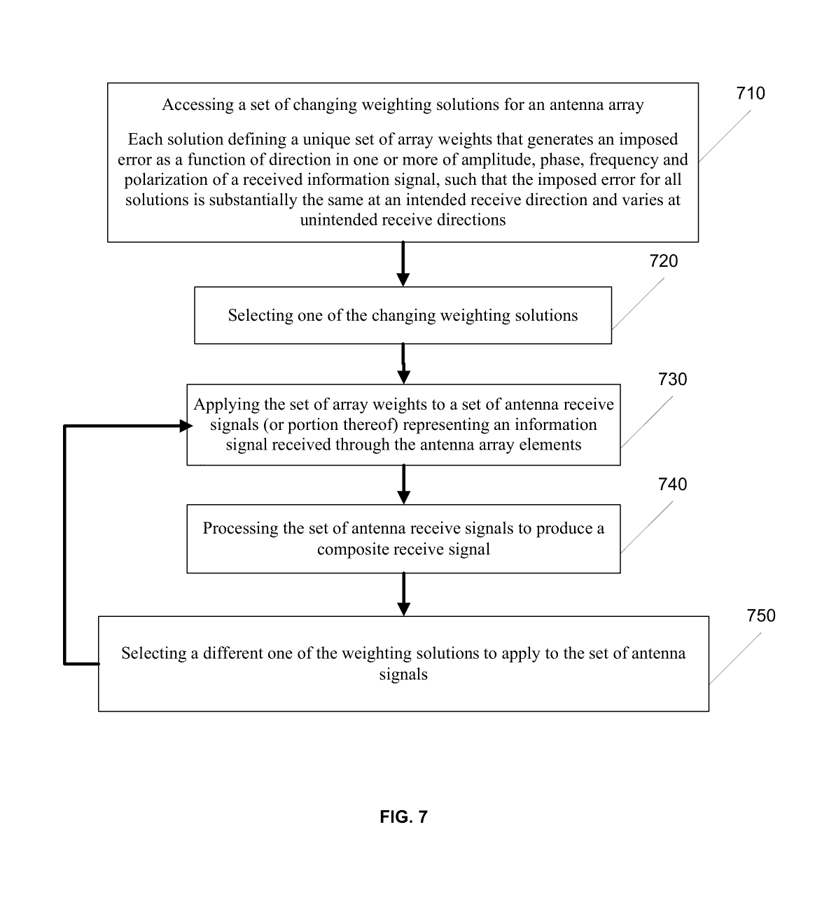

FIG. 7 is a flow diagram illustrating a method of implementing the ASIC effect in receive mode according to one embodiment. At 710, a set of changing weighting solutions exhibiting the ASIC effect may be obtained for the antenna array. Each solution may define a set of array weights that may generate an imposed error as a function of direction in one or more of amplitude, phase, frequency and polarization of a receive information signal. The imposed error may be substantially the same at intended direction(s) for all ASIC solutions and may vary at all other unintended directions. The set of ASIC solutions may be obtained by retrieving a preconfigured set of ASIC solutions stored in a database or by dynamically calculating the set of ASIC solutions.

In a dual stage weighting embodiment, the ASIC controller 345 may obtain the set of ASIC solutions after a set of beamforming weights are applied to the antenna receive signals by the beamformer 330. The obtained set may be based on the applied set of beamforming weights that correspond to an intended receive direction and a desired far field state for that direction. For example, the set of ASIC solutions may define array weights that produce the desired ASIC effect in that direction when applied to the weighted antenna receive signals from the beamformer 330 in a rotating manner, for example.

In a single stage weighting embodiment, the ASIC controller 345 may obtain the set of ASIC solutions prior to weighting by the beamformer 330. The obtained set may be based on a request from the beamformer controller 335 indicating an intended receive direction and optionally a desired far field state in that direction. For example, the obtained set of ASIC solutions may define array weights that produce the desired ASIC effect in the intended receive direction when applied to the antenna receive signals from the antenna array 350 in a rotating manner, for example. The ASIC controller 345 may be separate from, or incorporated into, the beamformer controller 345.

At 720, one of the changing weighting solutions may be selected by the ASIC controller 345.

At 730, the set of array weights defined by the selected weighting solution may be applied to a set of antenna receive signals representing an information signal (or portion thereof) being received. In the dual stage weighting embodiment, the ASIC weighter 340, under the control of the ASIC controller 345, may apply the ASIC array weights to the antenna receive signals from the beamformer 330. In the single stage weighting embodiment, the beamformer 330 may, under the control of the ASIC controller 345 (or under the combined control of the ASIC controller 345 and the beamformer controller 335), apply the ASIC array weights to the antenna receive signals from the antenna array 350.

At 740, the weighted antenna feed signals may be transmitted to the N to 1 feed network 320 for processing to produce a composite receive signal. As discussed above, ASIC weighting may impose a set of fully controlled amplitude, phase, frequency and polarization errors that vary as a function of angle to all received information signals. Such errors may be controlled so that they may collapse to zero in the direction(s) of an intended transmitter, and may be maximized in unintended directions. Therefore, the receiver, which processes the composite receive signal with ASIC weighting may only recover valid information signals from intended directions. Information signals received from all other directions may be corrupted by the imposed errors.

At 750, a different one of the weighting solutions may be selected to apply to the set of antenna receive signals back at 730. For example, the next weighting solution to apply may be selected according a predetermined or random sequence. The rate at which the different weighting solutions are selected and applied (“selection change rate”) may relate to the symbol rate of the information signal. For example, the selection change rate may be equal to the symbol rate of the information signal. As a result, errors that vary in amplitude, phase, polarization or frequency may be imposed in every received information symbol at unintended directions. The selection change rate may also be lower than the symbol rate of the information. Put another way, the ASIC effect may be periodically turned off reverting operation of the antenna array to its traditional performance and functionality. As a result, errors may be periodically imposed in the information signal received from unintended directions, such that data packets may be corrupted without altering the format of the received signal due to the ASIC effect. The selection change rate may also be defined to be higher than a symbol rate of the information signal. Higher selection rates may produce a spread spectrum effect as a function of direction, thereby altering the signal characteristics and bandwidth sent by transmitters located in unintended directions.

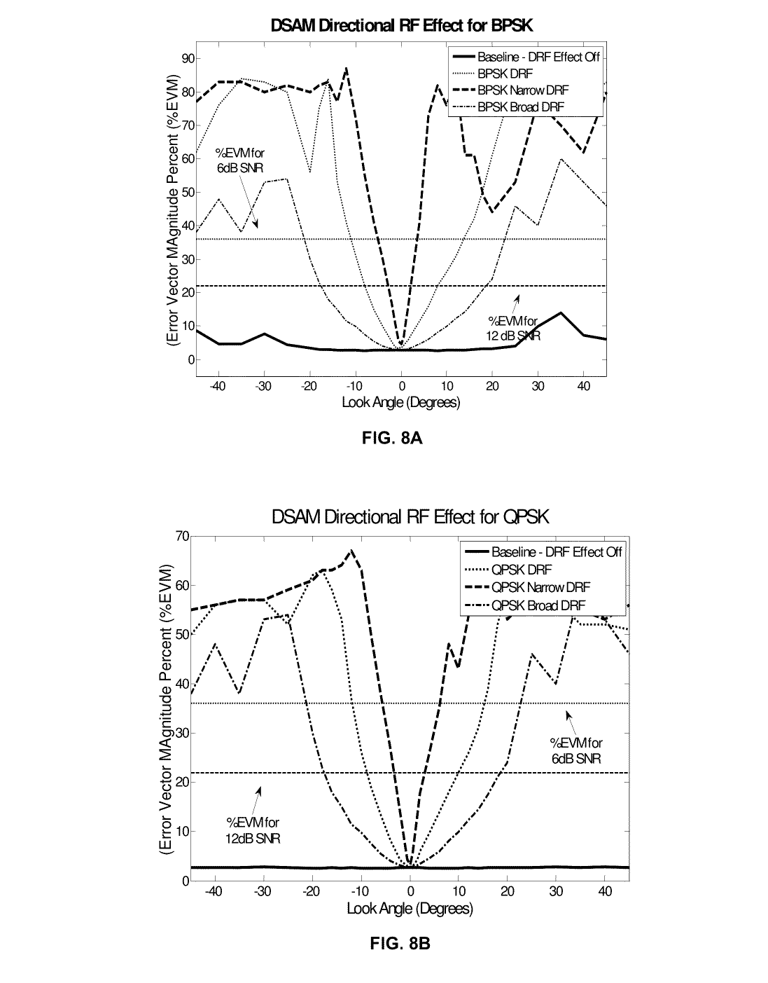

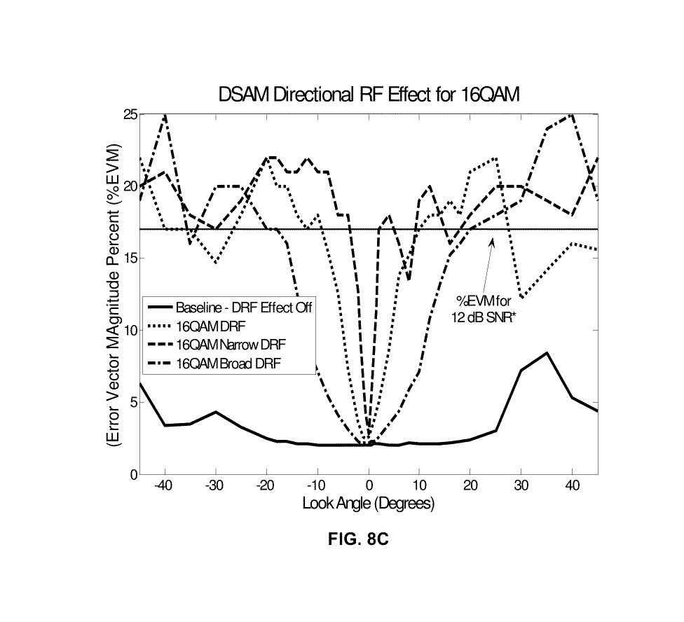

FIGS. 8A, 8B and 8C are exemplary diagrams comparing error imposed on an information signal as a function of direction for different types of data modulation and weighting solution sets. For example, FIG. 8A illustrates measured error statistics as a function of direction for different weighting solution sets (e.g., broad ASIC weighting, narrow ASIC weighting, nominal ASIC weighting, and no ASIC weighting) when applied to an information signal encoded using 2-symbol, binary phase shift keying (BPSK) modulation. Likewise, FIG. 8B and FIG. 8C illustrate measured error statistics for the different weighting solutions when applied to information signals encoded using 4-symbol, quadrature phase shift keying (QPSK) modulation and 16-symbol, quadrature amplitude modulation (16-QAM), respectively. As shown by each of these measured error statistics, the ASIC effect may be implemented to minimal error percentages at an intended direction (e.g., zero degrees) and higher error percentages at unintended directions away from the intended direction. In addition, these measured error statistics show that the ASIC effect may become more pronounced when applied to information signals encoded with modulation techniques having greater numbers of valid constellation symbol points.

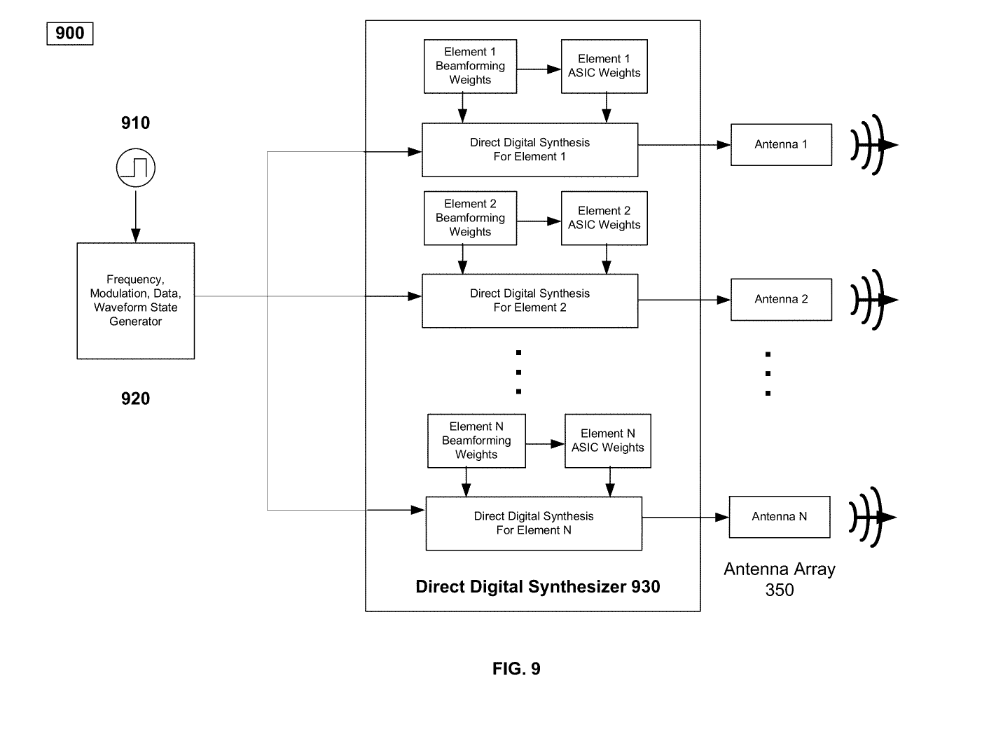

The transmitter system may also be implemented using digital techniques. For example, FIG. 9 is a diagram illustrating a direct digital synthesis (DDS) transmitter system that implements the ASIC effect according to one embodiment. The DDS transmitter system 900 may operate in a manner analogous to the analog transmitter system of FIG. 3, except that the generation and weighting of the antenna feed signals may be accomplished using direct digital synthesis techniques. For example, using digital data input from a digital data source 910, a state generator 920 may generate state information that represents the frequency, modulation, data and waveform for the information signal to be transmitted. This state information may be sent to the direct digital synthesizer 930 to generate the antenna feed signals. In particular, each unit of the direct digital synthesizer 930 generates a weighted antenna feed signal corresponding to a respective antenna array element. In addition to the state information from the state generator 920, each DDS unit may apply one or more sets of array weights. Consistent with the analog transmission system as described with respect to FIGS. 3 and 4, each DDS unit may apply a set of ASIC array weights alone or in combination with a separate set of beamforming weights. Regardless of the particular implementation, the weighted antenna feed signals may cause the antenna array to transmit the information signal in accordance with a desired ASIC effect, such that the information signal may be recoverable at intended direction(s) and not recoverable at all other unintended directions.

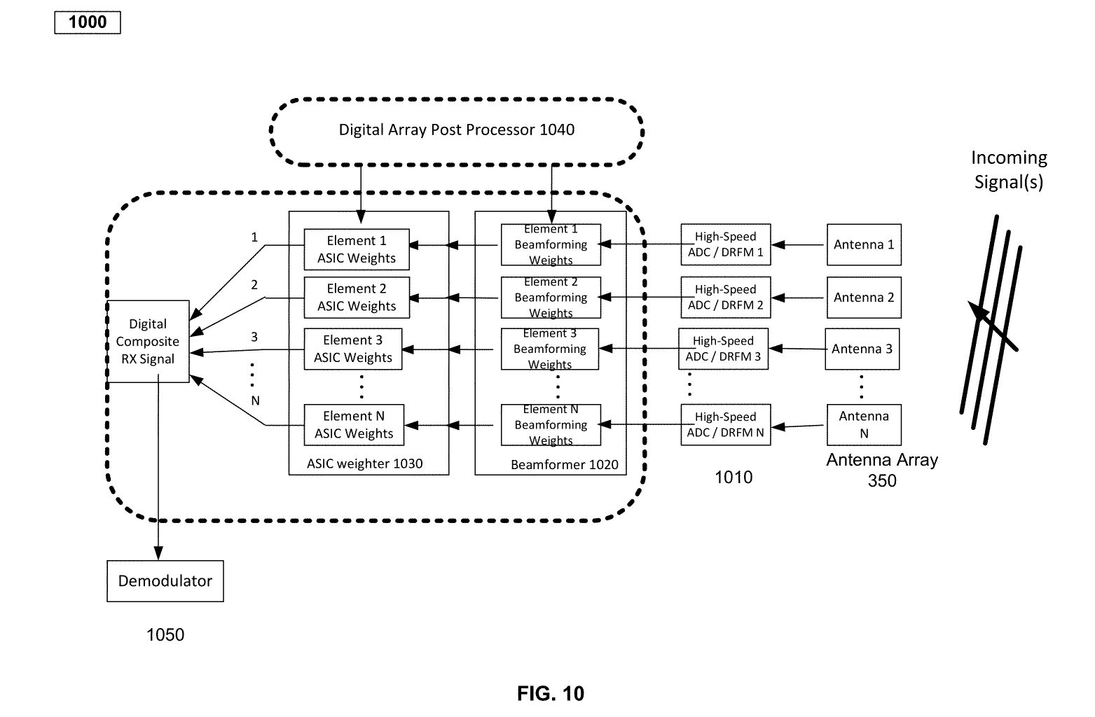

The receiver system may also be implemented using digital techniques. For example, FIG. 10 is a diagram illustrating a direct receiver system that implements the ASIC effect using a digital array post processing technique according to one embodiment. The digital receiver system 1000 may operate in a manner analogous to the analog receiver system of FIG. 6. However, in digital mode, the antenna may receive signals from the individual elements of the antenna array 350 that may be initially digitized by a set of high-speed analog-to-digital convertors (ADC) or digital RF memory (DRFM) 1010. Thereafter, a digital array post processor 1040 may control the application of a set of array weights to the digitized antenna receive signals by one or more of a ASIC weighter 1030 and a beamformer 1020. The digital weighting method is analogous to that of the analog receiver system as described in FIGS. 6 and 7. Therefore, the set of changing ASIC array weights may be applied alone or in combination with a separate set of beam forming weights. Regardless of the particular implementation, the weighted digitized antenna receive signals may then be processed to generate a digital composite receive signal. This composite receive signal may then be processed by demodulator 1050 in order to attempt to recover the information signal. As discussed above, ASIC weighting may impose a set of fully controlled amplitude, phase, frequency and polarization errors that vary as a function of angle to all received information signals. Such errors may be controlled so that they may collapse to zero in the direction(s) of an intended transmitter, and may be maximized in unintended directions. Therefore, the receiver, which processes the digital composite receive signal with ASIC weighting may only recover valid information signals from intended directions. Information signals received from all other directions may be corrupted by the imposed errors.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

What is claimed is:

1. A method of controlling communication of information signals at an intended direction through an antenna array, the method comprising:
obtaining a set of changing weighting solutions for an antenna array having at least two antenna array elements, each of the set of changing weighting solutions defining a set of array weights that generates an imposed error as a function of direction in at least one of amplitude, phase, frequency and polarization of an information signal transmitted or received by the antenna array, wherein the imposed error for all of the weighting solutions is substantially the same at an intended direction and varies at unintended directions;
selecting one of the set of changing weighting solutions;
applying the set of array weights of the selected changing weighting solution to a set of antenna signals corresponding to the information signal transmitted or received through the antenna array elements; and
selecting and applying each of the set of changing weighting solutions to the set of antenna signals according to a selection change rate, so that the information signal is recoverable at the intended direction and unrecoverable at all unintended directions.

2. The method of claim 1, wherein the intended direction comprises a range of intended directions.

3. The method of claim 1, wherein the selection change rate is equal to or lower than a symbol rate of the information signal.

4. The method of claim 1, wherein the selection change rate is higher than a symbol rate of the information signal.

5. The method of claim 1, wherein the set of array weights comprises one or more of amplitude and a phase corresponding to each antenna array element.

6. The method of claim 1, wherein the information signal is transmitted by the antenna array, the method comprising:
applying the set of array weights of the selected changing weighting solution to a set of antenna feed signals representing the information signal transmitted through the antenna array elements;
selecting and applying each of the set of changing weighting solutions to the set of antenna feed signals according to a selection change rate, so that the information signal is recoverable at the intended direction and unrecoverable at all unintended directions.

7. The method of claim 1, wherein the information signal is received by the antenna array, the method comprising:
applying the set of array weights of the selected changing weighting solution to a set of antenna receive signals corresponding to an information signal received through the antenna array elements;
processing the set of antenna receive signals to produce a composite receive signal; and
selecting and applying each of the set of changing weighting solutions to the set of antenna signals according to a selection change rate;
wherein the information signal is recoverable from the composite receive signal when the set of antenna receive signals is received from the antenna array at the intended direction and wherein the information signal is not recoverable when the set of antenna receive signals is received from the antenna array at any of the unintended directions.

8. A computing device for controlling communication of information signals at an intended direction, comprising:
a processor configured with processor-executable instructions to perform operations comprising:
accessing a set of changing weighting solutions for an antenna array having at least two antenna array elements, each of the set of changing weighting solutions defining a set of array weights that generates an imposed error as a function of direction in one or more of amplitude, phase, frequency and polarization of an information signal transmitted or received by the antenna array, wherein the imposed error for all of the weighting solutions is substantially the same at an intended direction and varies at unintended directions;
selecting one of the set of changing weighting solutions;
applying the set of array weights of the selected changing weighting solution to a set of antenna signals corresponding to the information signal transmitted or received through the antenna array elements; and
selecting and applying each of the changing weighting solutions to the set of antenna signals according to a selection change rate, so that the information signal is recoverable at the intended direction and unrecoverable at all unintended directions.

9. The computing device of claim 8, wherein the intended direction comprises a range of intended directions.

10. The computing device of claim 8, wherein the selection change rate is equal to or lower than a symbol rate of the information signal.

11. The computing device of claim 8, wherein the selection change rate is higher than a symbol rate of the information signal.

12. The computing device of claim 8, wherein the set of array weights comprises at least one of amplitude and a phase corresponding to each antenna array element.

13. The computing device of claim 8, wherein the information signal is transmitted by the antenna array and the processor is configured with processor-executable instructions to perform operations further comprising:
applying the set of array weights of the selected changing weighting solution to a set of antenna feed signals representing the information signal transmitted through the antenna array elements;
selecting and applying each of the changing weighting solutions to the set of antenna feed signals according to a selection change rate, so that the information signal is recoverable at the intended direction and unrecoverable at all unintended directions.

14. The computing device of claim 8, wherein the information signal is received by the antenna array and the processor is configured with processor-executable instructions to perform operations further comprising:
applying the set of array weights of the selected changing weighting solution to a set of antenna receive signals corresponding to an information signal received through the antenna array elements; and
processing the set of antenna receive signals to produce a composite receive signal;
selecting and applying each of the changing weighting solutions to the set of antenna signals according to a selection change rate;
wherein the information signal is recoverable from the composite receive signal when the set of antenna receive signals is received from the antenna array at the intended direction and wherein the information signal is not recoverable when the set of antenna receive signals is received from the antenna array at any of the unintended directions.

15. A computing device for controlling communication of information signals at an intended direction, comprising:
means for accessing a set of changing weighting solutions for an antenna array having at least two antenna array elements, each of the set of changing weighting solutions defining a set of array weights that generates an imposed error as a function of direction in one or more of amplitude, phase, frequency and polarization of an information signal transmitted or received by the antenna array, wherein the imposed error for all of the set of changing weighting solutions is substantially the same at an intended direction and varies at unintended directions;
means for selecting one of the set of changing weighting solutions;
means for applying the set of array weights of the selected changing weighting solution to a set of antenna signals corresponding to the information signal being transmitted or received through the antenna array elements; and
means for selecting and applying each of the changing weighting solutions to the set of antenna signals according to a selection change rate, so that the information signal is recoverable at the intended direction and unrecoverable at all unintended directions.

16. The computing device of claim 15, wherein the information signal is transmitted by the antenna array, the computing device further comprising:
means for applying the set of array weights of the selected changing weighting solution to a set of antenna feed signals representing the information signal transmitted through the antenna array elements;
means for selecting and applying each of the changing weighting solutions to the set of antenna feed signals according to a selection change rate, so that the information signal is recoverable at the intended direction and unrecoverable at all unintended directions.

17. The computing device of claim 15, wherein the information signal is received by the antenna array, the computing device further comprising:
means for applying the set of array weights of the selected changing weighting solution to a set of antenna receive signals corresponding to an information signal received through the antenna array elements; and
means for processing the set of antenna receive signals to produce a composite receive signal;
means for selecting and applying each of the changing weighting solutions to the set of antenna signals according to a selection change rate;
wherein the information signal is recoverable from the composite receive signal when the set of antenna receive signals is received from the antenna array at the intended direction and wherein the information signal is not recoverable when the set of antenna receive signals is received from the antenna array at any of the unintended directions.

18. A non-transitory storage medium having stored thereon processor-executable software instructions configured to cause a processor to perform operations comprising:
accessing a set of changing weighting solutions for an antenna array having two or more antenna array elements, each of the weighting solutions defining a set of array weights that generates an imposed error as a function of direction in one or more of amplitude, phase, frequency and polarization of an information signal transmitted or received by the antenna array, wherein the imposed error for all of the weighting solutions is substantially the same at an intended direction and varies at unintended directions;
selecting one of the set of changing weighting solutions;
applying the set of array weights of the selected changing weighting solution to a set of antenna signals corresponding to the information signal being transmitted or received through the antenna array elements; and
selecting and applying each of the changing weighting solutions to the set of antenna signals according to a selection change rate, so that the information signal is recoverable at the intended direction and unrecoverable at all unintended directions.

19. The non-transitory storage medium of claim 18, wherein the intended direction comprises a range of intended directions.

20. The non-transitory storage medium of claim 18, wherein the selection change rate is equal to or lower than a symbol rate of the information signal.

21. The non-transitory storage medium of claim 18, wherein the selection change rate is higher than a symbol rate of the information signal.

22. The non-transitory storage medium of claim 18, wherein the set of array weights comprises one or more of amplitude and a phase corresponding to each antenna array element.

23. The non-transitory storage medium of claim 18, wherein the information signal is transmitted by the antenna array and the stored processor-executable instructions is configured to cause the processor to perform operations further comprising:
applying the set of array weights of the selected changing weighting solution to a set of antenna feed signals representing the information signal transmitted through the antenna array elements;
selecting and applying each of the changing weighting solutions to the set of antenna feed signals according to a selection change rate, so that the information signal is recoverable at the intended direction and unrecoverable at all unintended directions.

24. The non-transitory storage medium of claim 18, wherein the information signal is received by the antenna array and the stored processor-executable instructions is configured to cause the processor to perform operations further comprising:
applying the set of array weights of the selected changing weighting solution to a set of antenna receive signals corresponding to an information signal received through the antenna array elements; and
processing the set of antenna receive signals to produce a composite receive signal;
selecting and applying each of the changing weighting solutions to the set of antenna signals according to a selection change rate;
wherein the information signal is recoverable from the composite receive signal when the set of antenna receive signals is received from the antenna array at the intended direction and wherein the information signal is not recoverable when the set of antenna receive signals is received from the antenna array at any of the unintended directions.
